(19) United States
(12) Patent Application Publication
(10) Pub. No.: US 2013/0254051 A1
(43) Pub. Date: Sep. 26, 2013

(54) APPARATUS FOR ISSUING RECEIPTS AND USER TERMINAL USING THE RECEIPTS

(71) Applicant: ELECTRONICS & TELECOMMUNICATIONS RESEARCH INSTITUTE, Daejeon (KR)

(72) Inventors: Soo Hyung KIM, Daejeon (KR); Jin Man CHO, Daejeon (KR); Jong Hyouk NOH, Daejeon (KR); Young Seob CHO, Daejeon (KR); Sang Rae CHO, Daejeon (KR); Dae Seon CHOI, Daejeon (KR); Seung Hyun KIM, Daejeon (KR); Seok Hyun KIM, Namak-ri (KR); Seung Hun JIN, Daejeon (KR)

(73) Assignee: Electronics & Telecommunications Research Institute, Daejeon (KR)

(21) Appl. No.: 13/785,381

(22) Filed: Mar. 5, 2013

(30) Foreign Application Priority Data
Mar. 21, 2012 (KR) 10-2012-0028538

(51) Int. Cl. G06Q 20/20

(52) U.S. Cl. CPC G06Q 20/202
USPC 705/21; 705/35

(57) ABSTRACT

There are disclosed a receipt issuing apparatus, a user terminal, a receipt issue system, and a method using smart receipts. The receipt issuing apparatus can include an issue unit configured to receive settlement information, configure a smart receipt based on the settlement information, and issue the configured smart receipt and a receipt transmission unit configured to send the issued smart receipt to a user terminal using short range wireless communication, wherein the smart receipt comprises at least one of information on a place of business, the settlement information, information on a transaction article, discount information, and an image of user signing.

### CROSS-REFERENCE(S) TO RELATED APPLICATION(S)

This application claims priority to Korean Patent Application No. 10-2012-0028538 filed on Mar. 21, 2012, which is incorporated herein by reference in its entirety.

### BACKGROUND OF THE INVENTION

1. Field of the Invention

Exemplary embodiments of the present invention relate to a smart receipt and, particularly, to an apparatus for issuing a smart receipt to a user terminal using wireless communication technology and a user terminal using the smart receipt.

2. Description of Related Art

A paper receipt commonly used in daily life has problems, such as the consumption of resources, an increase of costs, a leakage of personal information, and a danger of exposure to environmental hormones. In order to solve the problems, various forms of electronic receipts (or smart receipts) have emerged.

One of the techniques for issuing an electronic receipt can include a method of transferring information on cash payment by a customer to the mobile phone of the customer. In this case, there is a problem in that the customer can receive and check only some of pieces of information that may be checked in a paper receipt through the mobile phone. The customer can use the received receipt data only for a certain purpose, such as for a household account book, due to the problem. A fundamental reason why the information is inevitably limited and transferred is that information on a person's detailed purchasing (e.g., purchasing particulars, a card number, approval particulars, and discount particulars) cannot be consigned to and managed by third-party organizations, such as the server of a communication company and the server of the Office of National Tax Administration which do not belong to member stores or customers.

Another technique related to an electronic receipt includes a method in which the main body that has provided specific settlement means (e.g., a credit card) directly transfers the settlement particulars of a customer to the mobile phone of the customer, for example, in the form of a wireless message using the specific settlement means. In this technique, personal information can be protected because the main body that actually manages settlement particulars transfers the results of settlement to a customer, but a range of data transferred as the results of settlement is inevitably limited. Furthermore, this service is provided to only specific customers or by specific stores because a receipt can be issued only when corresponding settlement means are used. As a result, it is difficult to use this method as commercial technology.

As described above, there have emerged a variety of techniques in which the server of a seller or a specific server of a settlement infra-service provider and not a customer maintains, manages, and uses electronically represented receipt data. In the techniques, however, since receipts are chiefly transferred based on servers, a customer's act to receive a paper receipt directly is not accompanied, and a user manually checks messages transmitted by the servers. Accordingly, there are problems in that a user feels confusion and inconvenience resulting from experiences different from the existing experiences and additional costs necessary to operate the servers and transfer the messages are generated.

Furthermore, the existing electronic receipt service has a problem of construction costs because settlement infra-service providers or corresponding solution service providers, such as card companies and communication companies, require additional infrastructure and difficulties in expanding the service owing to complicated interests.

### SUMMARY OF THE INVENTION

An embodiment of the present invention is directed to providing a receipt issuing apparatus for issuing smart receipts to a user terminal using short range wireless communication technology.

Another embodiment of the present invention is directed to providing a user terminal for receiving and utilizing smart receipts.

Another embodiment of the present invention is directed to providing a receipt issuing system including the receipt issuing apparatus and the user terminal.

Another embodiment of the present invention is directed to providing supplementary service or store-unique service using the smart receipts.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a receipt issuing apparatus includes an issuing unit configured to receive settlement information, configure a smart receipt based on the settlement information, and issue the configured smart receipt and a receipt transmission unit configured to send the issued smart receipt to a user terminal using short range wireless communication, wherein the smart receipt includes at least one of; information on a place of business, the settlement information, information on a transaction article, discount information, and an image of user signing.

The receipt issuing apparatus may further include a settlement execution unit configured to perform the settlement in response to inputted information and output the settlement information.

The smart receipt further may include supplementary service information or store-unique information.

The supplementary service information may include at least one of; information on the location of a store, supplementary information related to a receipt wallet, and user supplementary information.

The store-unique information may include at least one of an article or service request information, store event coupon information, and service associated information.

Short range wireless communication may be used as the near field wireless communication. RFID, Zigbee, or Bluetooth may also be used as the short range wireless communication.

In accordance with another embodiment of the present invention, a user terminal includes a wireless reception unit configured to receive a smart receipt through short range wireless communication, a receipt wallet configured to store the smart receipt and information related to the smart receipt, and a control unit configured to perform control so that the received smart receipt is displayed, supplementary information related to the smart receipt is associated with the information related to the smart receipt when the supplementary information is received, the associated supplementary information is stored in the receipt wallet, and the stored supplementary information is displayed.

The user terminal may further include a user interface configured to display the smart receipt and the information related to the smart receipt to a user and transfer information, inputted by the user, to the control unit.

In accordance with another embodiment of the present invention, a smart receipt issuing system includes a receipt issuing apparatus configured to receive settlement information, configure a smart receipt based on the settlement information, issue the configured smart receipt, and send the issued smart receipt to a user terminal using short range wireless communication and a user terminal configured to receive the smart receipt from the receipt issuing apparatus through short range wireless communication, store the received smart receipt, display the received smart receipt, associate supplementary information related to the smart receipt with information related to the smart receipt when the supplementary information is received, and store the associated supplementary information.

In accordance with another embodiment of the present invention, an apparatus includes a method using smart receipts may include collecting data related to smart receipts from one or more user terminals, extracting supplementary service information or store-unique information from the collected data related to the smart receipt, and analyzing the extracted supplementary service information or store-unique information and providing supplementary service or store-unique service related to the smart receipt.

### BRIEF DESCRIPTION OF THE DRAWINGS

FIG. 1 is a conceptual diagram showing a smart receipt issue system in accordance with the present invention.

FIG. 2 is a diagram showing the structure of a smart receipt in accordance with the present invention.

FIG. 3 is a flowchart illustrating an operation of a receipt issuing apparatus issuing a smart receipt in accordance with the present invention.

FIG. 4 is a flowchart illustrating an operation of a user terminal in accordance with the present invention.

FIG. 5 is a diagram showing an embodiment of a method using the supplementary service information of a smart receipt in accordance with the present invention.

FIG. 6 is a diagram showing another embodiment of a method using the supplementary service information of a smart receipt in accordance with the present invention.

FIG. 7 is a diagram showing an embodiment of a method using the store-unique information of a smart receipt in accordance with the present invention.

FIG. 8 is a diagram showing another embodiment of a method using the store-unique information of a smart receipt in accordance with the present invention.

FIG. 9 is a block diagram of the user terminal in accordance with the present invention.

FIG. 10 is a block diagram of the receipt issuing apparatus in accordance with the present invention.

### DESCRIPTION OF SPECIFIC EMBODIMENTS

Exemplary embodiments of the present invention will be described below in more detail with reference to the accompanying drawings. However, the present invention is not limited to the specific embodiments, but should be interpreted as including all changes, equivalents, and substitutions included in the spirit and technical range of the present invention.

The terms used in this application are used to only describe the specific embodiments and are not intended to restrict the present invention. An expression of the singular number includes an expression of the plural number unless clearly defined otherwise in the context. In this application, terms, such as “comprise (or include)” or ‘have”, are intended to designate that characteristics, numbers, steps, operations, elements, or parts which are described in the specification, or a combination of them exist, and should be understood that they exclude the existence or possible addition of one or more other characteristics, numbers, steps, operations, elements, parts, or combinations of them in advance.

All the terms used herein, unless otherwise defined, have the same meanings which are typically understood by those having ordinary skill in the art. The terms, such as ones defined in common dictionaries, should be interpreted to have the same meanings as terms in the context of pertinent technology, and should not be interpreted to have ideal or excessively formal meanings unless clearly defined in the specification.

The term ‘terminal’ used in this application can also be referred to as a Mobile Station (MS), User Equipment (UE), a User Terminal (UT), a wireless terminal, an Access Terminal (AT), a terminal, a subscriber unit, a Subscriber Station (SS), a wireless device, a wireless communication device, a Wireless Transmit/Receive Unit (WTRU), a mobile node, a mobile, or other terms. A variety of embodiments of the terminal can include a cellular phone, a smart phone having a wireless communication function, a Personal Digital Assistant (PDA) having a wireless communication function, a wireless modem, a portable computer having a wireless communication function, a photographing device, such as a digital camera having a wireless communication function, a gaming device having a wireless communication function, music storage and playing home appliances having a wireless communication function, Internet home appliances enabling wireless Internet access and browsing, and portable units or terminals in which combinations of the functions are integrated, but not limited thereto.

Hereinafter, some exemplary embodiments of the present invention will be described in detail with reference to the accompanying drawings. In describing the present invention, in order to help overall understanding, the same reference numerals designate the same elements throughout the drawings, and a redundant description of the same elements is omitted.

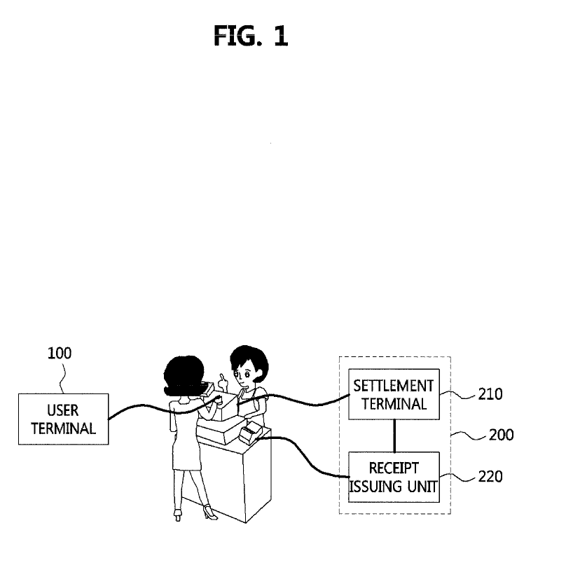

FIG. 1 is a conceptual diagram showing a smart receipt issue system in accordance with the present invention.

As shown in FIG. 1, the smart receipt issue system in accordance with the present invention can chiefly include a user terminal 100, that is, the terminal of a customer to which receipts are issued, the settlement terminal 210 and the receipt issuing unit 220 of a seller. The settlement terminal 210 and the receipt issuing unit 220 of a seller are illustrated as being coupled by a wired line, such as a cable, but they can be integrated into one hardware device 200.

A user, that is, a customer, owns the personal terminal 100 (e.g., a smart phone) in which customer terminal software (hereinafter referred to as a receipt wallet) for receiving and managing issued smart receipts and providing receipt data that is managed at need is installed. A seller owns the settlement terminal 210 for performing settlement and the receipt issuing unit 220 for directly sending a smart receipt, generated after settlement, to the personal terminal 100 of a customer using Near Field Communication (NFC) technology or one of other short range wireless communication technologies comparable to the NFC technology.

Here, NFC technology is near field wireless communication technology which provides wireless communication between devices placed within about 10 cm. NFC is an extension of the ISO/IEC 14443 contactless card or RFID standard, and it enables communication between NFC devices, but also communication with the existing ISO/IEEE 14443 reader or smart card.

NFC can operate in three types of mode: card emulation mode in which an NFC device (e.g., a mobile phone) operates likes the existing RFID card, reader mode in which an NFC device operates as a card reader, and P2P mode in which two NFC devices communicate with each other.

Furthermore, the greatest advantages of NFC are that a security problem is simple because coverage is very short and an initial setup time for communication is very short (e.g., 0.1 second or lower).

Furthermore, in the present invention, RFID, Zigbee, or Bluetooth can be used as short range wireless communication technology.

As described above, the settlement terminal 210 and the receipt issuing unit 220 of a seller can be combined into one device 200 (e.g., an NFC smart phone) in terms of hardware.

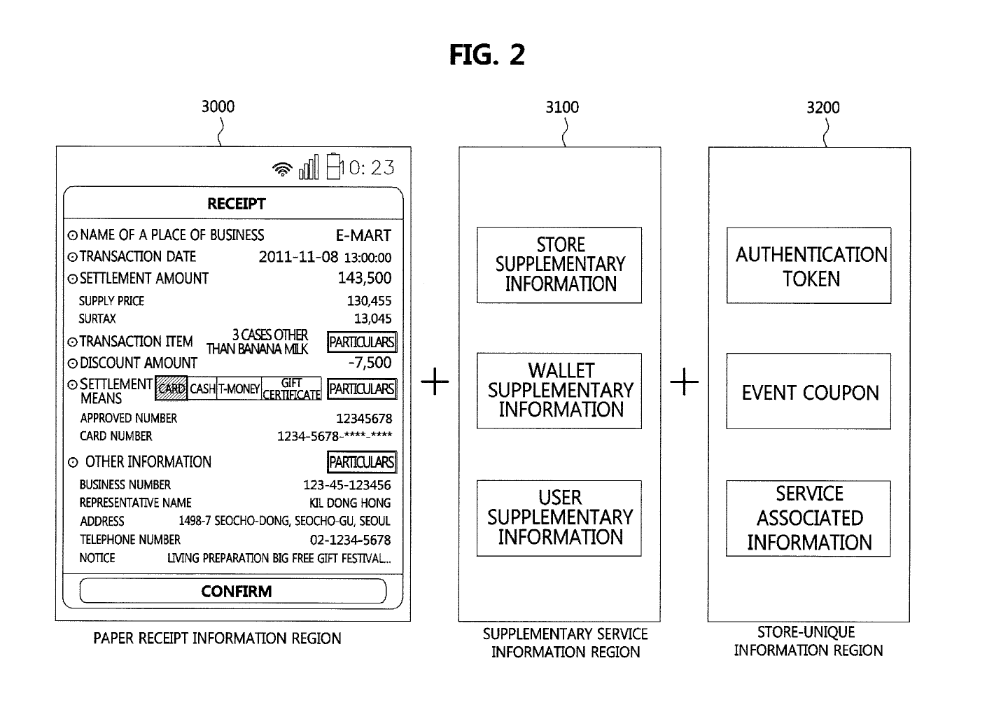

FIG. 2 is a diagram showing the structure of a smart receipt in accordance with the present invention.

A smart receipt includes a paper receipt information region 3000 for storing pieces of information included in a paper receipt, a supplementary service information region 3100, and a store-unique information region 3200. A smart receipt in accordance with the present invention essentially includes the data of the paper receipt information region 3000 and can optionally include the data of the supplementary service information region 3100 or the data of the store-unique information region 3200.

The paper receipt information region 3000 stores a name of a place of business, a transaction date, a settlement amount, a transaction item, a discount amount, settlement means, an image of customer signing, and other pieces of information. Here, an image of customer signing can be converted into an electronic image format and included in the user terminal. The signing image can be subsequently used as basic data for checking that a receipt is a smart receipt issued to a customer.

The supplementary service information region 3100 can include store supplementary information (e.g., the coordinates of the position of a store), wallet supplementary information (e.g., information registered when a smart receipt is issued to a receipt wallet), and user supplementary information (e.g., a store evaluation grade and preference service) which are not represented in the paper receipt.

The store supplementary information can be provided by a store that provides a smart receipt. The wallet supplementary information can be added to an issued smart receipt based on a determination of a smart receipt software providing company. Furthermore, the user supplementary information can be inputted by a user when the user checks an issued receipt through a receipt wallet or can be inputted by a user when the user checks a previously issued receipt through a receipt wallet.

Meanwhile, the store-unique information region 3200 can include an authentication token (e.g., an article or service request ticket and a parking ticket), an event coupon (e.g., a coupon unique to a store and an event participation coupon), and service associated information (e.g., association information for using services provided by a receipt issuing company). The authentication token can correspond to the integrity of a smart receipt itself or a security algorithm, an image, or mathematical calculation results for checking that a receipt has been issued to the customer himself.

A difference between the store-unique information region 3200 and the store supplementary information of the supplementary service information region 3100 is as follows. The store supplementary information means common format data which can be utilized in the applications of other traders (e.g., sellers or traders other than sellers) which utilize a receipt wallet or a smart receipt, whereas the store-unique information region 3200 means data having a unique format for subsequent utilization by a seller.

In the present invention, in order to prevent an arbitrary change of the contents of a smart receipt, an electronic integrity protection method can be applied to part of or the entire smart receipt. A secret or integrity protection method can be applied to the data of the store-unique information region 3200 of the smart receipt so that the data can be checked only in a device provided by a distributor only.

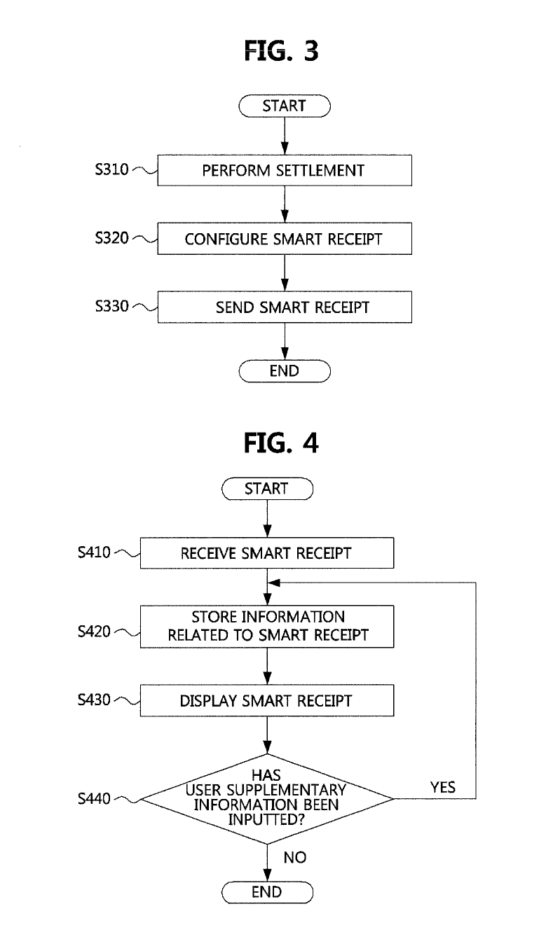

FIG. 3 is a flowchart illustrating an operation of a receipt issuing apparatus issuing a smart receipt in accordance with the present invention.

A method of the receipt issuing apparatus issuing a smart receipt can include performing, by a customer, settlement in a process of purchasing an article at step S310, configuring a smart receipt based on information on the settlement of the customer at step S320, and sending the configured smart receipt at step S330.

Here, the smart receipt is transmitted to a device (e.g., a mobile terminal, such as a mobile phone) owned by the customer using short range wireless transmission technology (e.g., NFC) installed in the receipt issuing apparatus provided in a store. If NFC technology is used as the near field wireless transmission technology, the customer needs to move the device to a place near the receipt issuing apparatus provided in the store.

At step S310, the customer performs settlement according to a common settlement procedure using settlement means (e.g., a mobile card, a plastic card, cash, or T-Cash) owned by the customer.

At step S320, the smart receipt is configured in the store based on information outputted to a paper receipt. Here, the smart receipt can be configured in the store by including store supplementary information in the smart receipt at need. At step S320, data belonging to the store-unique information region 3200 can be further included in the smart receipt as occasion demands.

At step S330, the configured smart receipt is transmitted to the device (e.g., a mobile phone) of the customer through the receipt issuing apparatus provided in the store and configured to have short range wireless transmission technology (e.g., NFC) installed therein.

FIG. 4 is a flowchart illustrating an operation of the user terminal in accordance with the present invention.

The operation of the user terminal in accordance with the present invention can chiefly include receiving a smart receipt at step S410, storing information related to the smart receipt at step S420, displaying the smart receipt at step S430, and inputting user supplementary information at step S440.

The user terminal in accordance with the present invention receives the smart receipt using, for example, short range wireless transmission technology at step S410. If NFC technology is used as the short range wireless transmission technology, a terminal user needs to move its own terminal device to a place near a device provided in a store, that is, within a distance where NFC communication is possible.

At step S420, the user terminal receives data related to the smart receipt that has been transmitted by a seller device and stores the received data in the receipt wallet of the user terminal. Here, the received data, together with wallet supplementary information, can be stored in the receipt wallet.

At step S430, the user terminal outputs the stored smart receipt so that the terminal user can check the received smart receipt. Here, if the user terminal provides a user interface, the terminal user who has checked the outputted smart receipt can input user supplementary information through the user interface at step S440. Here, the user supplementary information can include, for example, a user evaluation for a store.

If the terminal user has inputted the user supplementary information (Yes at step S440), the user terminal stores the inputted user supplementary information along with the smart receipt at step S420.

The present invention provides a variety of methods using the smart receipt. The methods using the smart receipt in accordance with the present invention can chiefly include collecting data related to the smart receipt from one or more user terminals, extracting supplementary service information or store-unique information from the collected data related to the smart receipt, analyzing the extracted supplementary service information or store-unique information, and providing the analyzed supplementary service or store-unique service related to the smart receipt.

Embodiments in which supplementary service or store-unique service are provided are described in detail below.

The supplementary service in accordance with the present invention is service using the data of the supplementary service region of the smart receipt. Two embodiments of the supplementary service are described below as examples, but a range of the supplementary service can be further extended.

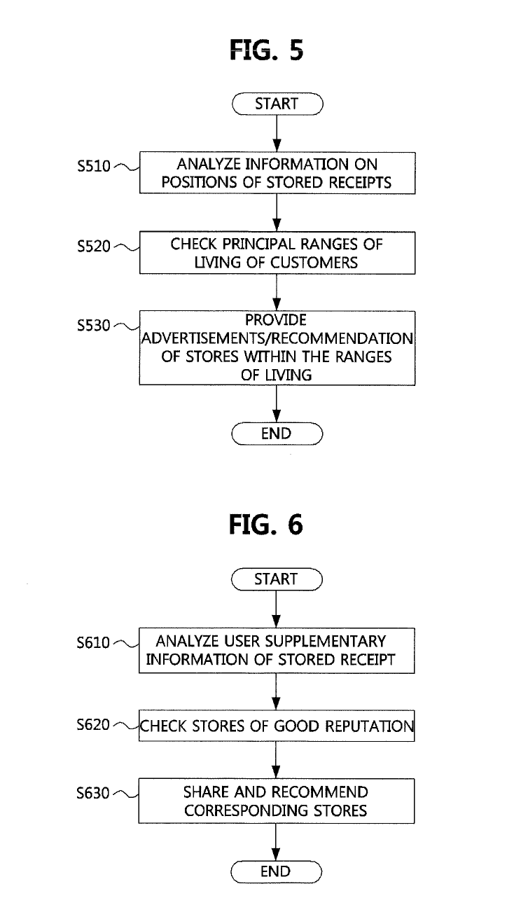

FIG. 5 is a diagram showing an embodiment of a method using the supplementary service information of a smart receipt in accordance with the present invention.

In the method using the supplementary service information shown in FIG. 5, data related to smart receipts is collected from one or more user terminals, information on the positions of stores is secured based on the collected data, and the secured information is analyzed at step S510. Furthermore, principal ranges of living of a customer are checked based on the analyzed information at step S520. Information on advertisements about stores or store recommendation information within the ranges of living based on the information on the positions is provided at step S530.

That is, the secured information on the positions of stores can be used to recommend stores suitable for a customer or can be utilized for advertisements that provide coupons. This utilization can be extended to advertisements for articles and services by analyzing articles or service information within a receipt.

An apparatus for providing supplementary service, such as that shown in FIG. 5, can be a user terminal for providing services by utilizing data stored in a receipt wallet or another application software using data stored in the receipt wallet or part of the data. Furthermore, if the data stored in the receipt wallet or part of the data moves from the user terminal to another device, application software installed in the device or the device itself can become the apparatus.

FIG. 6 is a diagram showing another embodiment of a method using the supplementary service information of a smart receipt in accordance with the present invention.

In the method using the supplementary service information shown in FIG. 6, user supplementary information stored in a stored receipt is analyzed at step S610 and stores of good customer reputation are checked at step S620. Information on the checked stores can be used for services in which the information is shared by or recommended to the friends of customers through Social Network Service (SNS) at step S630.

An apparatus for providing supplementary service, such as that shown in FIG. 6, can be a user terminal for providing services by utilizing data stored in a receipt wallet or another application software using data stored in the receipt wallet or part of the data. Furthermore, if the data stored in the receipt wallet or part of the data moves from the user terminal to another device, application software installed in the device or the device itself can become the apparatus.

The present invention can further provide unique service that uses the data of the store-unique information region of a smart receipt. The unique service is described below in connection with only two embodiments, but a range that provides the unique service can be further extended.

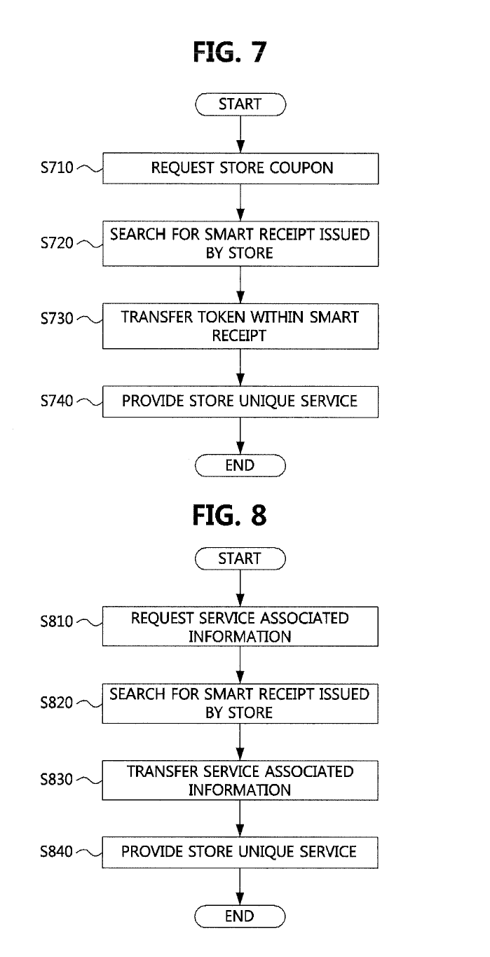

FIG. 7 is a diagram showing an embodiment of a method using the store-unique information of a smart receipt in accordance with the present invention.

In the method using the store-unique information shown in FIG. 7, store-unique service is provided in such a manner that the main body providing unique service requests store token information from one or more user terminals at step S710, the one or more user terminals search smart receipts, issued by sellers, for the tokens (i.e., tickets to request articles) of the sellers at step S720, and the one or more user terminals transfer the retrieved smart receipts to the main body that provides the store-unique service at step S730.

For example, if a user purchases a food ticket in a food court, a seller issues a smart receipt, including a food request ticket, to the user, the user can use an apparatus, installed at the corner where food is provided, for service that transfers the food request ticket.

The main body that provides store-unique service, such as that shown in FIG. 7, can be the application software of a seller that uses store-issued data stored in a receipt wallet or part of the store-issued data. Furthermore, if the store-issue data stored in the receipt wallet or part of the data is moved from a personal terminal to another device and used, the application software installed in the personal terminal or the personal terminal itself can become the main body.

FIG. 8 is a diagram showing another embodiment of a method using the store-unique information of a smart receipt in accordance with the present invention.

Unique service in accordance with the embodiment of FIG. 8 corresponds to application service in which service associated information (e.g., membership) of a seller that is included in a smart receipt issued by the seller is searched for in the smart receipt and the retrieved service associated information is provided to the main body that provides the unique service.

The method of providing unique service shown in FIG. 8 is started when the main body that provides unique service requests service associated information from one or more user terminals at step S810. In response to the request, the one or more user terminals search smart receipts, issued by stores, for service associated information at step S820 and provide the retrieved service associated information to the main body that provides unique service at step S830. The main body that provides unique service provides store-unique service based on the received service associated information at step S840.

For example, it is assumed that a confectionery wants to provide membership service or stamp service. In the case where a smart receipt is not used, for the purpose of the membership service or stamp service, a seller must issue membership cards or stamp paper to several users (or customers) and the customers must manage the membership cards or stamp paper in their customer wallets.

In accordance with the present invention, however, if a customer stores a membership ID or a stamp number in his smart receipt and provides it to a seller when the customer visits the seller's store, convenient service can be simply provided through the smart receipt system.

The main body that provides store-unique service, such as that shown in FIG. 8, can be the application software of a seller that uses store-issued data stored in a receipt wallet or part of the store-issued data. Furthermore, if the store-issue data stored in the receipt wallet or part of the data is moved from a personal terminal to another device and used, application software installed in the personal terminal or the personal terminal itself can become the main body.

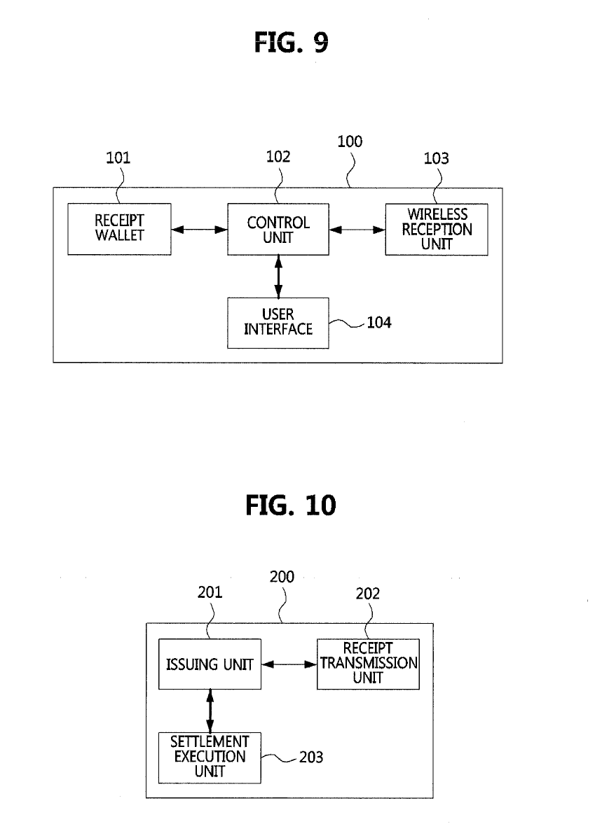

FIG. 9 is a block diagram of the user terminal in accordance with the present invention.

The user terminal 100 in accordance with the present invention can include a receipt wallet 101, a control unit 102, a wireless reception unit 103, and a user interface 104.

The receipt wallet 101 plays a role of a storage unit for storing various pieces of information related to a smart receipt in accordance with the present invention. The wireless reception unit 103 provides a short range wireless communication function for performing wireless communication with a receipt issuing apparatus and receives a smart receipt from the receipt issuing apparatus wirelessly. The user interface 104 displays various pieces of information on the smart receipt to a user and transfers information, inputted by the user, to the control unit 102.

The control unit 102 controls a receipt wallet 101 and a user interface 104 so that the received smart receipt is displayed, supplementary information related to the smart receipt is associated with the information on the smart receipt when the supplementary information is inputted, the associated supplementary information is stored in a receipt wallet, and the stored supplementary information is displayed.

FIG. 10 is a block diagram of the receipt issuing apparatus in accordance with the present invention.

The receipt issuing apparatus 200 in accordance with the present invention can include an issue unit 201, a receipt transmission unit 202, and a settlement execution unit 203.

The settlement execution unit 203 performs settlement in response to inputted information and outputs information on the settlement. FIG. 10 shows an example in which the settlement execution unit 203 is included in the receipt issuing apparatus in the form of one hardware device. In some embodiments, the settlement execution unit 203 can be separated from the issue unit 201 and the receipt transmission unit 202 in terms of hardware so that it is configured as an additional settlement terminal.

The issue unit 201 receives the information on the settlement, configures a smart receipt based on the received information, and issues the configured smart receipt. Furthermore, the receipt transmission unit 202 functions to send the issued smart receipt to the user terminal using short range wireless communication.

A smart receipt in accordance with the present invention includes pieces of information included in the existing paper receipt, such as information on a place of business, settlement information, information on a transaction article, discount information, and an image of user signing, and can include at least one of supplementary service information and store-unique information optionally.

Here, the supplementary service information can include at least one of information on the location of a store, supplementary information related to a wallet, and user supplementary information. Furthermore, the store-unique information can include at least one of article or service request information, store event coupon information, and service associated information.

In accordance with the embodiments of the present invention, the smart receipt can replace a paper receipt, and supplementary service and associated service can be provided using the smart receipt.

Furthermore, since service can be constructed based on only the mobile phone of a user and the settlement device of a store, there is an advantage in that electronic receipt service can be easily started owing to lots of advantages in terms of the simple structure of the smart receipt similar to a paper receipt, a cheap construction, and operating costs.

Furthermore, since the smart receipt is electronically transferred from the device of a seller to the device of a user using short range wireless communication technology, such as NFC, there are advantages in an intuitive and convenient issue, minimum construction costs, unnecessary additional settlement infrastructure, such as a server, a receipt issue not limited to specific settlement technology, and various supplementary service utilization using an issued receipt.

While the present invention has been described with respect to the specific embodiments, it will be apparent to those skilled in the art that various changes and modifications may be made without departing from the spirit and scope of the invention as defined in the following claims.

What is claimed is:

1. A receipt issuing apparatus, comprising:
an issuing unit configured to receive settlement information, configure a smart receipt based on the settlement information, and issue the configured smart receipt; and
a receipt transmission unit configured to send the issued smart receipt to a user terminal using short range wireless communication,
wherein the smart receipt comprises at least one of information on a place of business, the settlement information, information on a transaction article, discount information, and an image of user signing.

2. The receipt issuing apparatus of claim 1, further comprising a settlement execution unit configured to perform the settlement in response to inputted information and output the settlement information.

3. The receipt issuing apparatus of claim 1, wherein the smart receipt further comprises supplementary service information or store-unique information.

4. The receipt issuing apparatus of claim 3, wherein the supplementary service information comprises at least one of information on the location of a store, supplementary information related to a receipt wallet, and user supplementary information.

5. The receipt issuing apparatus of claim 3, wherein the store-unique information comprises at least one of article or service request information, store event coupon information, and service associated information.

6. The receipt issuing apparatus of claim 1, wherein the short range wireless communication is Near Field Communication (NFC).

7. A user terminal, comprising:
a wireless reception unit configured to receive a smart receipt through short range wireless communication;
a receipt wallet configured to store the smart receipt and information related to the smart receipt; and
a control unit configured to control the receipt wallet and a user interface, so as to display the received smart receipt, to associate supplementary information with the information related to the smart receipt when the supplementary information related to the smart receipt is received, to store the associated supplementary information in the receipt wallet, and to display the stored supplementary information.

8. The user terminal of claim 7, wherein the short range wireless communication is Near Field Communication (NFC).

9. The user terminal of claim 7, wherein the smart receipt comprises at least one of information on a place of business, settlement information, information on a transaction article, discount information, and an image of user signing.

10. The user terminal of claim 9, wherein the smart receipt further comprises supplementary service information or store-unique information.

11. The user terminal of claim 10, wherein the supplementary service information comprises at least one of information on the location of a store, supplementary information related to the receipt wallet, and user supplementary information.

12. The user terminal of claim 10, wherein the store-unique information comprises at least one of article or service request information, store event coupon information, and service associated information.

13. The user terminal of claim 7, further comprising a user interface configured to display the smart receipt and the information related to the smart receipt to a user and to transfer information, inputted by the user, to the control unit.

14. A method using smart receipts, comprising:
collecting data related to smart receipts from one or more user terminals;
extracting supplementary service information or store-unique information from the collected data related to the smart receipt; and
analyzing the extracted supplementary service information or store-unique information and providing supplementary service or store-unique service related to the smart receipt.

15. The method of claim 14, wherein the supplementary service information comprises at least one of information on the location of a store, supplementary information related to a receipt wallet, and user supplementary information.

16. The method of claim 14, wherein the store-unique information comprises at least one of article or service request information, store event coupon information, and service associated information.
